(19) United States
(12) Patent Application Publication
(10) Pub. No.: US 2024/0162454 A1
(43) Pub. Date: May 16, 2024

(54) AIR-COOLED PROTON-EXCHANGE MEMBRANE FUEL CELL CAPABLE OF WORKING WITH COMPRESSED GASES, AND FUEL CELLS STACK

(71) Applicant: ZeroAvia, Inc., Hollister, CA (US)

(72) Inventors: Aleksei IVANENKO, Moscow (RU); Sergei PANOV, Rybinsk (RU); Sergei SHUBENKOV, Moscow (RU); Aleksander TODOROV, Moscow (RU); John VOGEL, Charlton, NY (US); Rhonda STAUDT, Niskayuna, NY (US); Brian BENICEWICZ, Columbia, SC (US)

(73) Assignee: ZeroAvia, Inc., Hollister, CA (US)

(21) Appl. No.: 18/548,880

(22) PCT Filed: Mar. 4, 2021
(86) PCT No.: PCT/US21/20816

§ 371 Date: Sep. 1, 2023

(51) Int. Cl. H01M 8/0267; H01M 8/0208; H01M 8/04007

(52) U.S. Cl. CPC H01M 8/0267; H01M 8/0208; H01M 8/04067

(57) ABSTRACT

The present disclosure relates to fuel cells, in particular to high-temperature air-cooled fuel cells. A fuel cell 1 comprises a bipolar plate 2 and a membrane-electrode assembly 3. The bipolar plate 2 comprises an anode plate 5, a cathode plate 6 and a layer 7 of air cooling channels between the anode plate 5 and the cathode plate 6. Channels for an oxygen-containing gas are made in the cathode plate 6. Channels 10 for hydrogen are made in the anode plate 5, which are covered by the membrane-electrode assembly 3 contacting the anode plate 5. A fuel cell stack comprises at least two fuel cells, wherein the membrane-electrode assembly of one fuel cell contacts the anode plate of said one fuel cell, thus covering the channels for hydrogen, and contacts the cathode plate of said another fuel cell, which adjoins said one fuel cell, thus covering the channels for an oxygen-containing gas. The technical effect consists in reducing weight-dimension characteristics of the fuel cell and the fuel cell stack, while simultaneously reducing power consumption required for cooling, and increasing specific capacity per unit weight and power efficiency.

### CROSS REFERENCE TO RELATED APPLICATIONS

This application is a continuation of International Patent Application Number PCT/US21/20816, filed on Mar. 4, 2021, entitled “AIR-COOLED PROTON-EXCHANGE MEMBRANE FUEL CELL CAPABLE OF WORKING WITH COMPRESSED GASES, AND FUEL CELLS STACK” by IVANENKO et al., having Attorney Docket No. 18529-06-WO-PCA, and assigned to the assignee of the present application, which is incorporated herein by reference in its entirety.

### FIELD

The present disclosure relates to fuel cells, in particular to air-cooled proton-exchange membrane fuel cells.

### BACKGROUND

This section provides background information related to the present disclosure which is not necessarily prior art.

In the English-language literature, proton-exchange membrane fuel cells may relate to certain fuel cell classes, such as HTPEM FCs (high-temperature proton-exchange membrane fuel cells) and LTPEM FCs (low-temperature proton-exchange membrane fuel cells). The operating temperatures of low-temperature fuel cells (LTPEM FCs) range from app. 40° C. to app. 80° C., those of high-temperature fuel cells (HTPEM FCs) range from app. 120° to app. 200° C.

Document DE102016200398A1 discloses a bipolar plate having three separate plates for proton-exchange membrane fuel cells, which is characterized by mechanical strength, but can still have flexible configuration. The bipolar plate comprises an anode plate having a first structure for forming an anode flow field, a cathode plate, and a coolant plate for forming a coolant flow. The coolant plate is arranged between the anode plate and the cathode plate.

Document EP1805837B1 describes a fuel cell comprising a membrane-electrode assembly, an anode plate and a cathode plate, both having flow channels, and a separate coolant plate which is arranged on the rear side of the cathode plate and is designed for heat removal and temperature control. All the fuel cells are combined into a stack and held with the use of a clamping mechanism. Inlets and outlets for hydrogen, air and water are provided on the end plates.

According to another document, US20180254494A1, a bipolar plate for fuel cells comprises a flow plate having a first surface for the introduction of hydrogen fuel gas and water vapor, and a second surface for the introduction of an oxygen containing gas, wherein at least a portion of the first and/or second surface comprises a nanostructured carbon material coating.

The above technical solutions known in the art are characterized by liquid cooling of a fuel cell, but a specific feature of the claimed fuel cell is air cooling. Air cooling of a fuel cell enables to eliminate an intermediate coolant which is a cooling liquid. Thereby, a weight of a cooling system and a bipolar plate included into a fuel cell is reduced many times, power consumption for cooling is decreased, and, finally, a power unit specific capacity for unit weight and its power efficiency are improved, which are the key parameters of FC-based power units, especially for flying applications.

Variants of air-cooled fuel cells are also known in the art.

In particular, document CN210576224U discloses a fuel cell which bipolar plate consists of two parts welded together. The cathode plate comprises triangular air grooves with through holes, which are produced by extruding a corrugated plate. Air comes from the through holes to a membrane-electrode assembly (hereinafter also MEA) for a reaction. The anode plate is a flat flow field plate with parallel grooves, the groove width being 1 mm and the groove depth being 0.4 mm. Flows of air and hydrogen are parallel to each other.

A fuel cell bipolar plate according to document CN211829028U also consists of two parts. The corrugated cathode plate has a staggered structure. Corrugation enables to use one part of air for a reaction and the other part for cooling the system. Hydrogen channels are straight. Two embodiments are proposed: hydrogen and air flows are parallel to each other; or hydrogen and air flows are perpendicular to each other.

Another document, CN211829029U, discloses an air-cooled fuel cell, wherein gas flows (air, hydrogen) are straight and perpendicular to each other. The cathode plate is a buckled plate with straight channels, and a plurality of through holes are distributed along the channel length, which enables air to enter into neighboring channels. Hydrogen channels are straight.

All these air-cooled fuel cells known in the art comprise a two-layer bipolar plate. Their structural features are aimed at modifying the cathode plate, namely at various ways of making corrugated structures for passing uncompressed air. A disadvantage of the above fuel cells is, particularly, the use of uncompressed air for an electrochemical reaction, which affects dimensions and a specific capacity per weight unit and power efficiency of a fuel cell. Moreover, the above documents do not teach a possibility of applying their structures for making HTPEM FCs.

### SUMMARY

This section provides a general summary of the disclosure, and is not a comprehensive disclosure of its full scope or all of its features.

Thus, the objective of the present disclosure is to develop a proton-exchange membrane fuel cell structure that may combine advantages of liquid- and air-cooled proton-exchange membrane fuel cells, but, at the same time, may be deprived of their disadvantages. Such a fuel cell should be compact, simple and reliable structurally, and, at the same time, should have high characteristics of specific capacity per unit weight and power efficiency.

The technical effect of the claimed disclosure is lowering of weight-dimension characteristics of fuel cells and a fuel cell stack made thereof together with reduction of power consumption required for cooling them, and increase in specific capacity per unit weight and power efficiency.

The above objective is solved and the claimed technical effect is achieved by the claimed fuel cell due to the fact that, unlike the air-cooled proton-exchange membrane fuel cells known in the art, the proposed fuel cell comprises a three-layer bipolar plate wherein three media are used: hydrogen for an anode plate, a compressed oxygen-containing gas (e.g. air) for an electrochemical reaction, i.e. for a cathode plate, and uncompressed air for cooling the fuel cell, the air passing along corresponding channels for air cooling which are arranged between the anode plate and the cathode plate. The anode plate of the bipolar plate contacts an anode of a membrane-electrode assembly, and hydrogen channels made in the anode plate are covered by the membrane-electrode assembly to prevent them from contacting the environment. The cathode plate of the bipolar plate similarly contacts the cathode of an adjoining membrane-electrode assembly, and channels of the cathode plate are similarly isolated from environment.

The claimed fuel cell structure is compact and has a low weight, nevertheless providing the possibility of supplying a compressed (i.e. pressurized) oxygen-containing gas for an electrochemical reaction, which has a positive impact on specific capacity per unit surface and unit weight of a fuel cell and on its power efficiency.

The above objective is solved and the claimed technical effect is achieved also in particular embodiments of the disclosure, which, however, do not limit it in any way.

Thus, preferably, a layer of air cooling channels, channels for air and channels for hydrogen are located substantially in parallel planes, which ensures, simultaneously, compactness of the structure and improved heat transfer between components of the fuel cell. Moreover, the most preferable shape of the fuel cell is rectangular, wherein, in particular, the channels for an oxygen-containing gas in the cathode plate may be oriented substantially along the long side of the fuel cell, and the air cooling channels may be oriented substantially along the short side of the fuel cell.

Further, it is preferable that the anode plate, the cathode plate and/or the layer of the air cooling channels are made of a material having high heat conductivity, high electric conductivity and low density, preferably of aluminium, magnesium, beryllium, titanium alloys or composite materials based on graphite films or graphene. Moreover, the anode plate and the cathode plate may have a corrosion-resistant and electrically conductive protective coating.

The above objective is solved and the claimed technical effect is achieved by another subject of the present disclosure, i.e. a fuel cell stack comprising at least two fuel cells, as described above, or their variants. In the fuel cell stack, the membrane-electrode assembly of one fuel cell contacts the anode plate of this fuel cell, thus covering the channels for hydrogen, and the cathode plate of another fuel cell adjoining the first one, thus covering the channels for an oxygen-containing gas.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a general view of one embodiment of the claimed fuel cell in a partially disassembled state.

FIG. 2 shows a general view of an embodiment of the bipolar plate used in the claimed fuel cell in a partially disassembled state.

The following designations are used in the drawings for indicating the components:
1—fuel cell;
2—bipolar plate;
3—membrane-electrode assembly;
4—frame;
5—anode plate;
6—cathode plate;
7—layer of air cooling channels;
8—side panel;
9—sealing element (ring);
10—channels for hydrogen.

Corresponding reference numerals indicate corresponding parts or features throughout the several views of the drawings.

### DETAILED DESCRIPTION

Example embodiments will now be described more fully with reference to the accompanying drawings.

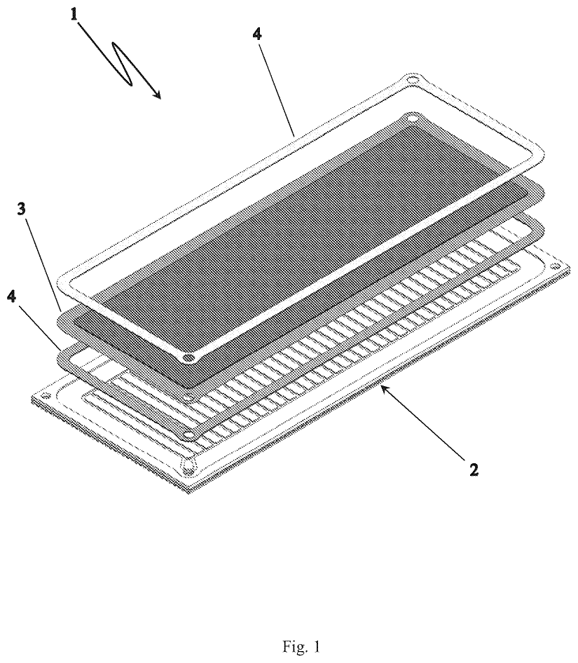

A fuel cell 1 according to the disclosure is schematically shown in FIG. 1. The fuel cell 1 comprises a bipolar plate 2 and a membrane-electrode assembly 3. A person skilled in the art will understand that the fuel cell 1 may also comprise components sealing it and, in addition, facilitating fixation of a position of the membrane-electrode assembly 3 relative to the bipolar plate 2, e.g. frames 4, as shown in FIG. 1, which are made of a gas-tight elastic material.

As it is said above, the claimed fuel cell 1 relates to proton-exchange membrane fuel cells that relate to the HTPEM FC and LTPEM FC classes of fuel cells. The operating temperatures of these fuel cells range from app. 120° to 200° C. and from 40° to 80° C., respectively.

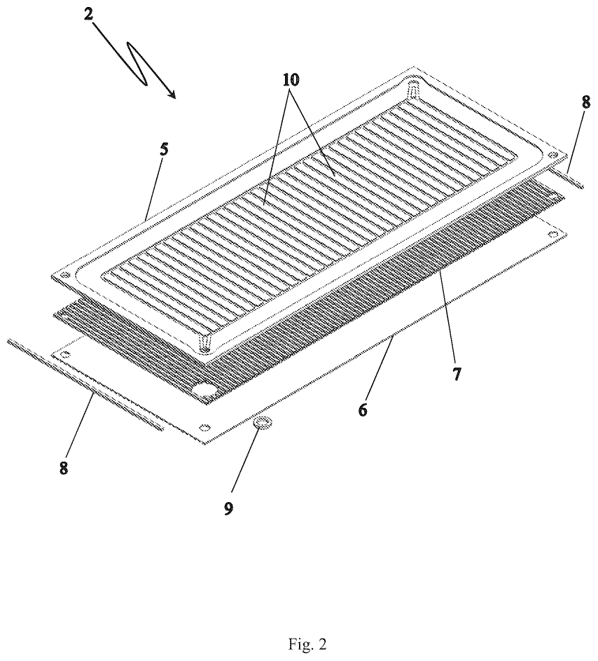

The bipolar plate 2, incorporated into the fuel cell 1, which possible embodiment is shown in FIG. 2, comprises an anode plate 5, a cathode plate 6 and a layer 7 of air cooling channels, the layer 7 being arranged between the anode plate 5 and the cathode plate 6. A person skilled in the art will understand that the bipolar plate 2 may also comprise elements designed for increasing its rigidity and durability, e.g. side panels 8 shown in FIG. 2; taking into consideration the fact that the fuel cell is in a fuel cell stack in a compressed state. The bipolar plate may also comprise sealing elements, which are required for organizing gas headers, such as, for example, a sealing element (ring) 9 that is required for forming a hydrogen supplying header. A person skilled in the art will understand that the components of the assembled bipolar plate 2 are secured to each other by soldering or welding.

Channels 10 for hydrogen, preferably compressed hydrogen involved in an electrochemical reaction, are made in the anode plate 5. On top (as shown in FIG. 2), the channels 10 for hydrogen are covered by the membrane-electrode assembly 3. Hydrogen, in particular compressed hydrogen, may be supplied to the anode plate 5 from headers formed with the use of the rings 9 arranged in the stack perpendicularly to the plane of the fuel cell 1 and may be distributed over the channels 10 for distributing hydrogen over the surface of the membrane-electrode assembly 3.

Channels (not shown in the drawings) for an oxygen-containing gas are made in the cathode plate 6, e.g., for air, oxygen, a mixture of oxygen with one or more gases, which gas is required for an electrochemical reaction. In order to organize supply of an oxygen-containing gas, headers may be used that are similar to hydrogen headers. An oxygen-containing gas is fed into channels for an oxygen-containing gas, preferably under pressure, by, e.g. a compressor. This ensures a more intensive electrochemical reaction and, correspondingly, an increased capacity of the fuel cell 1. For this, it is necessary to supply an oxygen-containing gas from one of the short ends of the bipolar plate, in order not to impede organization of cooling air supply, which is possible, for example, by making the fuel cell 1 rectangular and arranging the channels for an oxygen-containing gas in the cathode plate 6 substantially along a long side of the fuel cell 1. In this configuration, the channels for an oxygen-containing gas are, on the one hand, long, but, on the other hand, do not generate a high gas-dynamic resistance to an oxygen-containing gas flow, since they are, preferably, straight, and a velocity of an oxygen-containing gas flow is rather low in comparison to a cooling air flow. Channels for an oxygen-containing gas may have various cross-sections, for example rectangular, trapezoidal, semicircular, circular, polygonal, etc.

The layer 7 of air cooling channels is arranged in the bipolar plate 2 between the anode plate 5 and the cathode plate 6. The air cooling channels are made preferably from a foil. This structure of the bipolar plate 2 and the whole fuel cell 1 is the main distinguishing feature of the present disclosure, since it enables to eliminate an intermediate liquid coolant and, thus, lower the weight of the cooling system and the bipolar plate 2 as well as reduce power inputs required for cooling. Finally, this enables to increase specific capacity per unit weight of the fuel cell 1.

Air to be passed via the layer 7 of the air cooling channels is taken from the environment without pre-compression or with small compression (compression coefficient is less than 1.5). Air may be pre-heated up to a temperature in the range from 100 to 140° C. without additional power inputs, for example, by mixing it with hot air taken from the outlet of the fuel cell 1, and, thus, partial recirculation of cooling air may be realized.

During making the fuel cell 1 of a rectangular shape, the air cooling channels are preferably oriented along a short side of the fuel cell 1, in order to minimize a temperature gradient in the fuel cell 1, though in this case they may have a complex shape. The air cooling channels may have various cross-sections, for example rectangular, trapezoidal, semicircular, circular, etc. Correspondingly, cooling air is supplied from one of the long ends of the fuel cell 1.

Thus, an air flow for cooling the fuel cell 1 and an oxygen-containing gas flow for conducting an electrochemical reaction are separated. In this case, the flows of these gases as well as a hydrogen flow pass substantially in parallel planes, which ensures both compactness of the structure of the fuel cell 1 and its good cooling, and, consequently, enables to increase specific capacity per unit weight and power efficiency of the fuel cell 1.

In a preferred embodiment of the fuel cell 1, the anode plate 5, the cathode plate 6 and the layer 7 of the air cooling channels may be made of a material having high heat conductivity, high electric conductivity and low density. Such materials are, in particular, aluminium, magnesium, beryllium, titanium alloys or composite materials based on graphite films or graphene. Moreover, the anode plate 5 and the cathode plate 6 may have a corrosion-resistant and electrically-conductive protective coating.

The claimed fuel cell 1 can be operated as follows.

Hydrogen at ambient pressure or compressed is supplied to the anode plate 5. A compressed oxygen-containing gas, for example air, is supplied to the cathode plate 6. After this, an electrochemical reaction occurs which results in producing electric energy by the fuel cell 1. The fuel cell 1 is cooled by supplying air at ambient pressure or insignificantly compressed into the layer 7 of the air cooling channels. As it is said above, air for cooling may be pre-heated to a temperature in the range from 100 to 140° C., including without additional power inputs, for example, by mixing it with hot air taken from the outlet of the fuel cell 1.

A fuel cell stack (not shown in the drawings) is formed from two or more fuel cells 1 described in detail above, including their possible variants. In the fuel cell stack, the membrane-electrode assembly 3 contacts, by its one side, the anode plate 5 of the fuel cell 1, thus covering the channels 10 for hydrogen, and by its other side it contacts the cathode plate 6 of another fuel cell 1 adjoining the first fuel cell, thus covering the channels for an oxygen-containing gas of said another fuel cell 1.

Thus, the claimed fuel cell and, consequently, the fuel cell stack are compact and have a small weight, nevertheless providing the possibility of supplying a compressed oxygen-containing gas for an electrochemical reaction, which has a positive impact on specific capacity per unit weight and power efficiency of the fuel cell and the fuel cell stack.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A fuel cell comprising a bipolar plate and a membrane-electrode assembly, wherein: the bipolar plate comprises an anode plate, a cathode plate, and a layer of air cooling channels between the anode plate and the cathode plate,
channels for an oxygen-containing gas are provided in the cathode plate, and
channels for hydrogen are provided in the anode plate,
the membrane-electrode assembly contacting the anode plate, thus covering said channels for hydrogen.

2. The fuel cell of claim 1, wherein the layer of the air cooling channels, channels for air and channels for hydrogen are substantially in parallel planes.

3. The fuel cell of claim 1, wherein the anode plate, the cathode plate and/or the layer of the air cooling channels are made of a material having high heat conductivity, high electric conductivity and a low density, preferably of aluminium, magnesium, beryllium, titanium alloys or composite materials based on graphite films or graphene.

4. The fuel cell of claim 1, which has a substantially rectangular shape.

5. The fuel cell of claim 4, wherein the air cooling channels are oriented substantially along a short side of the fuel cell.

6. The fuel cell of claim 1, wherein the anode plate and the cathode plate have a protective electrically conductive coating.

7. A fuel cell stack comprising at least two fuel cells according to any one of claims 1-6, wherein the membrane-electrode assembly of one fuel cell contacts the anode plate of this one fuel cell, thus covering the channels for hydrogen, and the cathode plate of another fuel cell, which adjoins said one fuel cell, thus covering the channels for an oxygen-containing gas.
